(19) United States
(12) Patent Application Publication
(10) Pub. No.: US 2024/0296257 A1
(43) Pub. Date: Sep. 5, 2024

(54) Floorplan Transformation Matrix Generation for Augmented-Reality System

(71) Applicant: ARway Corporation, Toronto (CA)

(72) Inventors: Daniel T. Yu, Cupertino, CA (US); Shadnam S. Khan, Toronto (CA); Nima Sarshar, Miami, FL (US); Nikhil, Rajasthan (IN)

(21) Appl. No.: 18/590,540

(22) Filed: Feb. 28, 2024

Related U.S. Application Data
(60) Provisional application No. 63/488,364, filed on Mar. 3, 2023.

(51) Int. Cl. G06F 30/12; G06F 30/13; G06F 111/18

(52) U.S. Cl. CPC G06F 30/12; G06F 30/13; G06F 2111/18

(57) ABSTRACT

An augmented reality (AR) system creates a transformation matrix for conversions between real and virtual spaces based on a given floorplan indicating the physical locations of location markers. These markers may include machine-readable labels or identifiable landmarks. The AR system receives images of the physical space from a content-generating device, along with each image's pose data, indicating the device's position when capturing the image. The system generates a transformation matrix by comparing pose data for each image to the floorplan's indicated location marker. The system may update a position component based on discrepancies between predicted and actual physical locations. This transformation matrix, associated with the specific physical space, is stored for future use.

### CROSS-REFERENCE TO RELATED APPLICATIONS

This application claims the benefit of U.S. Provisional Application No. 63/488,364, entitled “Generating 3D Digital Twin from Property Floorplan Images for Navigation Systems” and filed Mar. 3, 2023, which is incorporated by reference.

### BACKGROUND

Augmented reality systems provide augmented realty (AR) content to users. This content displays virtual objects within the context of the user's environment such that virtual object appears to be real. However, to properly render the virtual objects so that they appear real, augmented reality systems require information about structures in the physical space around a user. Generating a three-dimensional (3D) model of the physical space is generally a time-intensive endeavor because a user must manually create the virtual model of the physical space. Furthermore, the user must provide a mechanism for the augmented reality system to convert from physical locations in the physical space to virtual locations in the virtual model and vice versa. This mechanism can be difficult to create and is generally inaccurate.

### SUMMARY

An augmented reality system generates a transformation matrix for conversions between the physical world and a virtual world based on a received floorplan that has indicators of the physical locations of location markers. A floorplan is a two-dimensional (2D) representation or depiction of a structure within a physical space. The floorplan indicates where a set of location markers are located within the physical space. A location marker is a physical object located within a physical space that is used to correlate physical location data to locations in a floorplan. For example, a location marker may be a machine-readable label, such as a barcode or a QR code, or may be a landmark within the physical space. The augmented reality system receives images of the physical space from the content generation device. These images depict one of the set of location markers identified in the floorplan. The augmented reality system also receives pose data associated with each image. The pose data for an image indicates a pose of the content generation device when the image was captured.

The augmented reality system generates a transformation matrix for a virtual model of the physical space. The transformation matrix is a matrix that effects a transformation (e.g., an affine transformation) between physical locations within the physical space and virtual locations within a virtual model of the physical space. To generate the transformation matrix, the augmented reality system compares the pose data for each received image to the location on the floorplan of the location marker depicted in the received image. In some embodiments, the augmented reality system updates a position component of an initially generated transformation matrix by applying the initially generated transformation matrix to the physical locations of the location markers and updating the position component based on errors between the predicted physical locations and the actual physical locations. The augmented reality system stores the transformation matrix in association with the physical space for which it was generated.

### BRIEF DESCRIPTION OF DRAWINGS

FIG. 1 illustrates an example system environment for an augmented reality system, in accordance with one or more embodiments.

FIG. 2 is a flowchart illustrating an example method for generating a virtual model of a physical space, in accordance with some embodiments.

FIG. 3 illustrates an example user interface for uploading a floorplan and adding locations 310 of location markers onto the floorplan, in accordance with some embodiments.

FIG. 4 illustrates an example computation of the errors between predicted physical locations and actual physical locations of a set of location markers in a physical space, in accordance with some embodiments.

### DETAILED DESCRIPTION

The figures depict various embodiments of the present configuration for purposes of illustration only. One skilled in the art will readily recognize from the following discussion that alternative embodiments of the structures and methods illustrated herein may be employed without departing from the principles of the configuration described herein.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

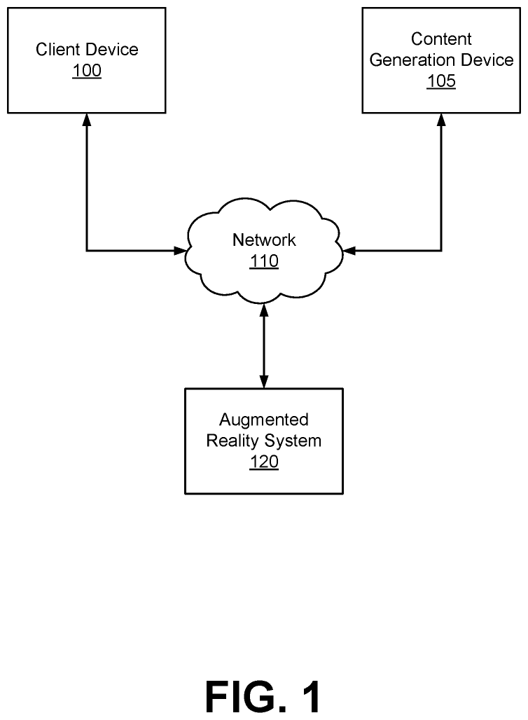

FIG. 1 illustrates an example system environment for an augmented reality system 120, in accordance with one or more embodiments. The system environment illustrated in FIG. 1 includes a client device 100, a content generation device 105, a network 110, and an augmented reality system 120. The client device 100, the content generation device 105, the augmented reality system, and the network may be computing devices. One or more computing devices may be a computing system. The computing system may include one or more processors (processing system) and a memory. The memory may be a non-transitory computer readable storage medium. The non-transitory computer readable storage medium may store program code that includes instructions executable by the processing system. The program code may correspond to the processes described herein.

Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

The client device 100 is a device through which a user may interact with the augmented reality system 120. The client device 100 can be a personal or mobile computing device, such as a smartphone, a tablet, a laptop computer, or desktop computer.

In some embodiments, the client device 100 executes a client application that uses an application programming interface (API) to communicate with the augmented reality system 120. The client device 100 presents augmented reality (AR) content to the user through a display. The client device 100 captures pose data using sensors coupled to the client device to determine what AR content to display. This pose data describes the pose of the client device over time. For example, the client device may collect camera data, global navigation satellite system (GNSS) data, inertial measurement unit (IMU) data, or gyroscopic data.

The client device 100 uses a virtual model of the physical world to determine what content to display to the user. The virtual model is a 3D model that represents a physical space around the client device 100. For example, the virtual model may be a mesh structure that represents physical space or may describe planes that represents walls and floors of a physical space. The client device 100 may receive the virtual model from the augmented reality system and use the virtual model locally to display AR content. The client device 100 also may provide pose data to the augmented reality system 120 and the augmented reality system 120 uses the virtual model of the physical space to determine what content to present to the user.

A physical space, as used herein, is a physical area that is modeled by the augmented reality system 120. A physical space may be a geographic region, such as a city or country, or may be areas that correspond to certain physical structures, such as a mall, amusement park, or airport. The physical space may be defined by a content generation device 105 associated with the physical space, such as the operator of a mall or amusement park. For example, the physical space may be defined with the physical locations of the boundaries that define the physical space (e.g., longitude and latitude).

The content generation device 105 is a client device used by an operator or manager associated with a physical space to generate a virtual model of the physical space and generate AR content to display to users within the physical space. The content generation device 105 may generate the virtual model using a 2D floorplan of the physical space and by capturing images of markers within the physical space. An example process for generating a virtual model using a floorplan is described in further detail below.

A user of the content generation device 105 places AR content within the virtual model by generating the AR content (e.g., a virtual object) and indicating a pose of the AR content relative to the virtual model. For example, the content generation device 105 may provide a client application with a user interface for setting a pose of the AR content within the virtual model. The client application may also allow a user to generate the AR content to be placed within the virtual model or may allow a user to import AR content to the client application to be added to the virtual model. The content generation device 105 may transmit an updated virtual model with the AR content for storage by the augmented reality system 120.

The client device 100, the content generation device 105, and the augmented reality system 120 can communicate with each other via the network 110. The network 110 is a collection of computing devices that communicate via wired or wireless connections. The network 110 may include one or more local area networks (LANs) or one or more wide area networks (WANs). The network 110, as referred to herein, is an inclusive term that may refer to any or all of standard layers used to describe a physical or virtual network, such as the physical layer, the data link layer, the network layer, the transport layer, the session layer, the presentation layer, and the application layer. The network 110 may include physical media for communicating data from one computing device to another computing device, such as MPLS lines, fiber optic cables, cellular connections (e.g., 3G, 4G, or 5G spectra), or satellites. The network 110 also may use networking protocols, such as TCP/IP, HTTP, SSH, SMS, or FTP, to transmit data between computing devices. In some embodiments, the network 110 may include Bluetooth or near-field communication (NFC) technologies or protocols for local communications between computing devices. The network 110 may transmit encrypted or unencrypted data.

The augmented reality system 120 is an online system that provides AR content to client devices for display to users in physical spaces. The augmented reality system 120 receives pose data from client devices 100 that indicate which physical space the client device is located within and identifies a virtual model that corresponds to that physical space. The augmented reality system 120 may render augmented reality content using the identified virtual model and transmit that content to the client device 100 for display to the user, or may transmit the virtual model to the client device 100 for a client application to render the AR content locally. The augmented reality system 120 receives AR content from content generation devices 105 and stores the AR content in association with a corresponding virtual model. The received AR content may be the content that the augmented reality system 120 renders (or a local client application renders) for display to a user.

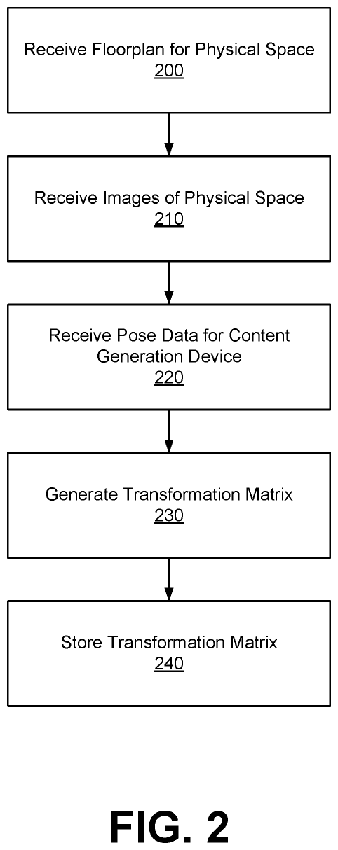

FIG. 2 is a flowchart illustrating an example method for generating a virtual model of a physical space, in accordance with some embodiments. While primarily described below as steps performed by an augmented reality system, the steps of the method may be performed, individually or jointly, by a client device 100, a content generation device 105, or the augmented reality system 120. Alternative embodiments may include more, fewer, or different steps from those illustrated in FIG. 2 and the steps may be performed in a different order from that illustrated in FIG. 2. Additionally, this method may be performed automatically by augmented reality system or may be performed in response to human instructions.

The augmented reality system receives 200 a floorplan from a content generation device. A floorplan is a 2D representation or depiction of a structure within a physical space. For example, the floorplan may depict where walls are located, how tall the walls are, or where stairs or elevators are. The floorplan may be an image with lines depicting where structures are. In these cases, the augmented reality system may apply computer vision algorithms or models to the received floorplan to extract the structure from the floorplan. Alternatively, the floorplan may include structured data that defines structures in the physical area.

The floorplan indicates where a set of location markers are located within the physical space. A location marker is a physical object located within a physical space that is used to correlate physical location data to locations in a floorplan. For example, a location marker may be a machine-readable label, such as a barcode or a QR code, or may be a landmark within the physical space. A client application operating on the content generation device may include a user interface that allows a user to indicate a location of a location marker on an initial floorplan that the user uploaded. The client application may modify the floorplan data associated with the floorplan to include the indicated locations of the location markers and transmit that modified floorplan to the augmented reality system. In some embodiments, the location for a location marker is a 2D location on the floorplan. Alternatively, the location for a location marker may include a third dimension indicating a height of the location marker off of the floor.

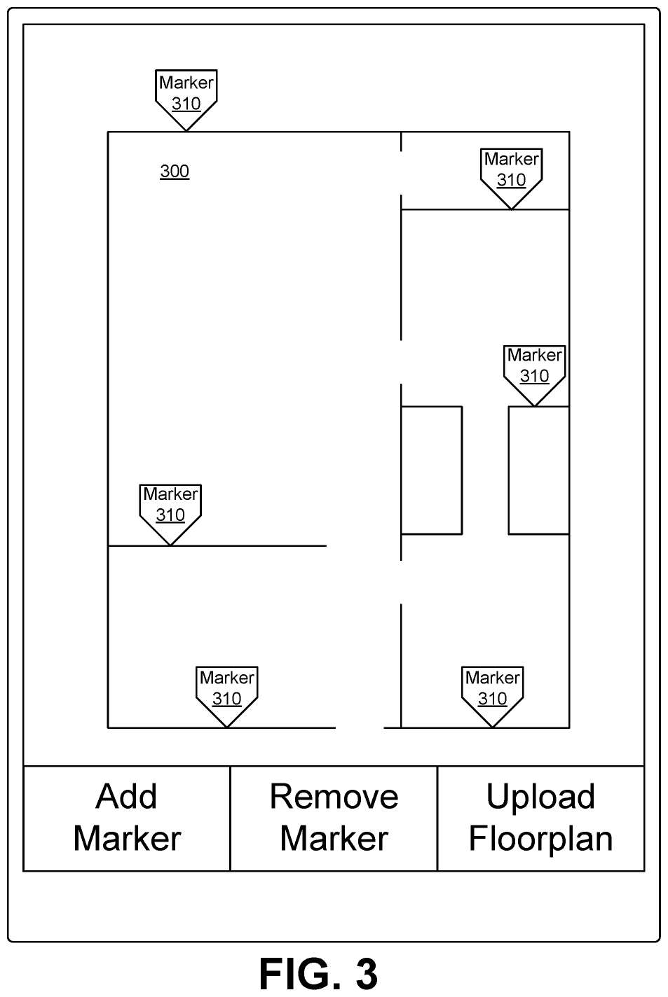

FIG. 3 illustrates an example user interface for uploading a floorplan 300 and adding locations 310 of location markers onto the floorplan 300, in accordance with some embodiments. The example user interface may be displayed as part of a client application operating on a content generation device. The user can use this user interface to add indications of where locations are located within a physical area.

The augmented reality system receives 210 one or more images of the physical space from the content generation device. These images depict one of a set of location markers identified in the floorplan. Each image may include metadata identifying which marker of the set of markers is depicted. Alternatively, the augmented reality system identifies the location marker based on the received image. For example, where the location marker is a machine-readable label, the identification information for the location marker may be encoded in the label itself and the augmented reality system may extract the identification information from image. Similarly, where the location marker is a landmark, the augmented reality system may apply computer-vision models or algorithms to identify the landmark from the image.

The augmented reality system also receives 220 pose data associated with each image. The pose data for an image indicates a pose of the content generation device when the image was captured. For example, the pose data may include location data describing a location of the content generation device within the physical space (e.g., GNSS data) or may include orientation data describing an orientation of the content generation device (e.g., gyroscopic data) or may include position data describing the position of content generation device (e.g., accelerometer).

The augmented reality system generates 230 a transformation matrix for a virtual model of the physical space. The transformation matrix is a matrix that effects a transformation (e.g., an affine transformation) between physical locations within the physical space and virtual locations within a virtual model of the physical space. The augmented reality system may thereby apply the transformation matrix to vectors representing locations within the physical space to generate a vector representing virtual locations in a virtual model (and vice versa).

To generate the transformation matrix, the augmented reality system compares the pose data for each received image to the location on the floorplan of the location marker depicted in the received image. The augmented reality system may, more specifically, compute a least squares regression of the pose data of the received images and the locations of the location markers to generate the transformation matrix. In some embodiments, the augmented reality system computes a physical world location of a location marker depicted in an image by determining a position of the location marker relative to the content generation device based on the image and the pose data. For example, the augmented reality system may determine the relative position of the location marker to the content generation device based on the pose of the content generation device, the position of the location marker in the image, the size of the location marker in the image, or a tangent plane to the surface of the location marker. The augmented reality system uses that relative position and the pose data from the content generation device to determine the location of the location marker in the physical space.

In some embodiments, the augmented reality system updates a position component of the transformation matrix by applying an initially generated transformation matrix to the physical locations of the location markers. When generating a transformation matrix based on a set of data points, the stretch and rotation components of the transformation matrix tend to be relatively accurate when the matrix is initially generated.

The position component of the matrix could potentially be relatively inaccurate due to inaccuracies in measuring the pose of the content generation device and in determining the location of location markers. To minimize the inaccuracy in the position component, the augmented reality system generates an initial transformation matrix, as described above, and applies that initial transformation matrix to the virtual locations of the location markers on the floorplan to generate predicted physical locations of the location markers in the physical space (or vice versa).

The augmented reality system compares the predicted physical locations to the actual physical locations to compute an error value. This error value is a value that represents the overall error of the predicted physical locations versus the actual physical locations. For example, the error value may be a mean difference of the predicted physical locations and actual physical locations. The augmented reality system updates the position component of the initial transformation matrix based on the computed error value and uses the updated transformation matrix for transformations for the physical space.

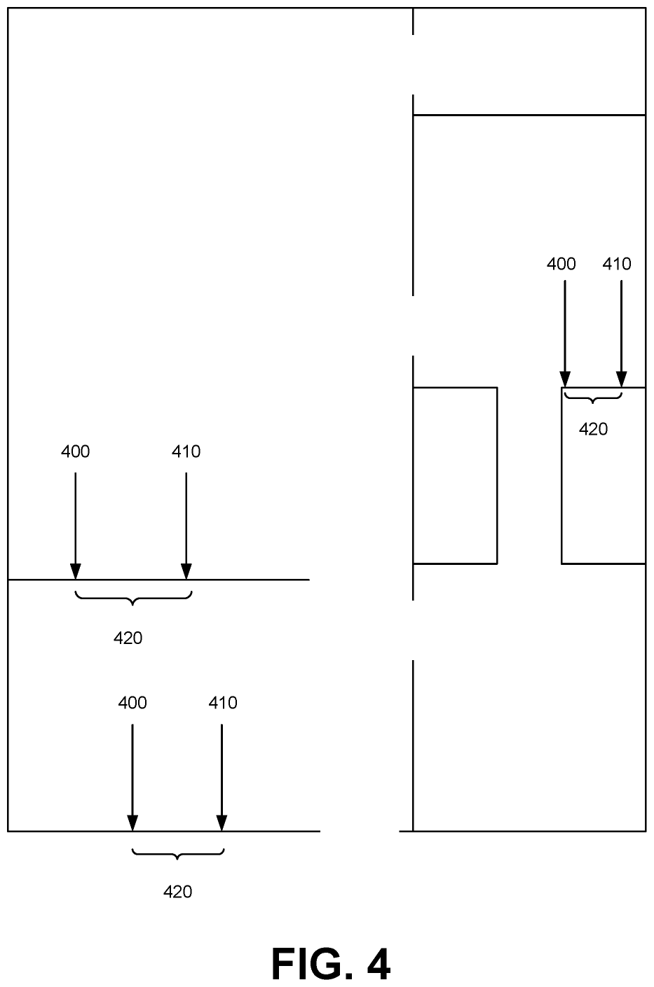

FIG. 4 illustrates an example computation of the errors 420 between predicted physical locations 400 and actual physical locations 410 of a set of location markers in a physical space, in accordance with some embodiments. The augmented reality system may compute an average of the errors 420 and adjust the transformation matrix based on that computed average so that the transformation matrix generates more accurate predicted physical locations.

The augmented reality system stores 240 the transformation matrix in association with the corresponding physical space. The augmented reality system may use the stored transformation in the presentation of AR content for the physical space. For example, the augmented reality system may use the transformation matrix to transform the virtual locations of AR content relative to a virtual model of the floorplan to corresponding physical locations in the physical space. The augmented reality system may use these physical locations to determine how to render virtual objects for users based on the position of the user relative to an intended position at which the AR content should appear to be located. Similarly, the augmentation reality system may use the transformation matrix to convert a client device's physical location in the physical space to a corresponding virtual location within a virtual model of the physical space.

### Additional Considerations

By using location markers to generate a transformation matrix for a physical space, the augmented reality system improves the onboarding process for users by making it easier for users to generate a virtual model of their physical spaces. Additionally, by updating the position component of the transformation matrix, the augmented reality system improves the accuracy of the transformation matrix.

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

1. A method comprising:
receiving a floorplan for a physical space, the floorplan having indication of locations of a plurality of location markers within the physical space relative to the floorplan;
receiving a plurality of images of the physical space, each image depicting a location marker of the plurality of location markers;
receiving physical pose data for each of the plurality of images, the physical pose data for an image representing of a pose of a client device that captured the image when the image was captured;
generating a transformation matrix for a virtual model of the floorplan based on the floorplan, the plurality of images, and the physical pose data, the transformation matrix being a matrix that transforms physical locations of the physical space to virtual locations within the virtual model; and
storing the transformation matrix in a computer-readable medium in association with the physical space.

2. The method of claim 1, wherein generating the transformation matrix based on the physical pose data further comprises:
computing a physical location for each of the plurality of location markers based on the physical pose data and the plurality of images.

3. The method of claim 2, wherein computing a physical pose for a location marker further comprises:
computing a physical location of the client device based on the physical pose data; and
computing a relative position of the location marker to the client device based on the physical pose data for an image depicting the location marker.

4. The method of claim 2, wherein generating the transformation matrix further comprises:
generating an initial transformation matrix;
applying the initial transformation matrix to the locations for the plurality of location markers relative to the floorplan to generate a plurality of predicted physical locations of the plurality of location markers;
comparing the plurality of predicted physical locations to the computed physical locations for the plurality of locations markers; and
updating a position component of the initial transformation matrix based on the comparison to generate an updated transformation matrix.

5. The method of claim 4, wherein comparing the plurality of predicted physical locations to the computed physical locations further comprises:
computing an average error value.

6. The method of claim 1, wherein receiving the floorplan further comprises:
receiving, through a user interface of a client application, the locations of the plurality of location markers on the floorplan.

7. The method of claim 1, wherein each location marker of the plurality of location markers comprises a machine-readable label.

8. A computer-readable medium comprising stored instructions that when executed by one or more processors, cause the one or more processors to:
receive a floorplan for a physical space, the floorplan having indication of locations of a plurality of location markers within the physical space relative to the floorplan;
receive a plurality of images of the physical space, each image depicting a location marker of the plurality of location markers;
receive physical pose data for each of the plurality of images, the physical pose data for an image representing of a pose of a client device that captured the image when the image was captured;
generate a transformation matrix for a virtual model of the floorplan based on the floorplan, the plurality of images, and the physical pose data, the transformation matrix being a matrix that transforms physical locations of the physical space to virtual locations within the virtual model; and
store the transformation matrix in a computer-readable medium in association with the physical space.

9. The non-transitory computer-readable medium of claim 8, wherein the instructions to generate the transformation matrix based on the physical pose data further comprises instructions that when executed causes the one or more processors to:
compute a physical location for each of the plurality of location markers based on the physical pose data and the plurality of images.

10. The computer-readable medium of claim 9, wherein the instructions to compute a physical pose for a location marker further comprises instructions that when executed causes the one or more processors to:
compute a physical location of the client device based on the physical pose data; and
compute a relative position of the location marker to the client device based on the physical pose data for an image depicting the location marker.

11. The computer-readable medium of claim 9, wherein the instructions to generate the transformation matrix further comprises instructions that when executed causes the one or more processors to:
generate an initial transformation matrix;
apply the initial transformation matrix to the locations for the plurality of location markers relative to the floorplan to generate a plurality of predicted physical locations of the plurality of location markers;
compare the plurality of predicted physical locations to the computed physical locations for the plurality of locations markers; and
update a position component of the initial transformation matrix based on the comparison to generate an updated transformation matrix.

12. The computer-readable medium of claim 11, wherein the instructions to compare the plurality of predicted physical locations to the computed physical locations further comprises instructions that when executed causes the one or more processors to:
compute an average error value.

13. The computer-readable medium of claim 8, wherein the instructions to receive the floorplan further comprises instructions that when executed causes the one or more processors to:
receive, through a user interface of a client application, the locations of the plurality of location markers on the floorplan.

14. The computer-readable medium of claim 8, wherein each location marker of the plurality of location markers comprises a machine-readable label.

15. A system comprising:
one or more processors; and
a non-transitory computer-readable medium comprising stored instructions that, when executed by the one or more processors, causes the system to:
receive a floorplan for a physical space, the floorplan having indication of locations of a plurality of location markers within the physical space relative to the floorplan;
receive a plurality of images of the physical space, each image depicting a location marker of the plurality of location markers;
receive physical pose data for each of the plurality of images, the physical pose data for an image representing of a pose of a client device that captured the image when the image was captured;
generate a transformation matrix for a virtual model of the floorplan based on the floorplan, the plurality of images, and the physical pose data, the transformation matrix being a matrix that transforms physical locations of the physical space to virtual locations within the virtual model; and
store the transformation matrix in a computer-readable medium in association with the physical space.

16. The system of claim 15, wherein the instructions to generate the transformation matrix based on the physical pose data further comprises instructions that, when executed by the one or more processors, causes the system to:
compute a physical location for each of the plurality of location markers based on the physical pose data and the plurality of images.

17. The system of claim 16, wherein the instructions to compute a physical pose for a location marker further comprises instructions that, when executed by the one or more processors, causes the system to:
compute a physical location of the client device based on the physical pose data; and
compute a relative position of the location marker to the client device based on the physical pose data for an image depicting the location marker.

18. The system of claim 16, wherein the instructions to generate the transformation matrix further comprises instructions that, when executed by the one or more processors, causes the system to:
generate an initial transformation matrix;
apply the initial transformation matrix to the locations for the plurality of location markers relative to the floorplan to generate a plurality of predicted physical locations of the plurality of location markers;
compare the plurality of predicted physical locations to the computed physical locations for the plurality of locations markers; and
update a position component of the initial transformation matrix based on the comparison to generate an updated transformation matrix.

19. The system of claim 18, wherein the instructions to compare the plurality of predicted physical locations to the computed physical locations further comprises instructions that, when executed by the one or more processors, causes the system to:
compute an average error value.

20. The system of claim 15, wherein the instructions to receive the floorplan further comprises instructions that, when executed by the one or more processors, causes the system to:
receive, through a user interface of a client application, the locations of the plurality of location markers on the floorplan.
